(19) United States
(12) Patent Application Publication
(10) Pub. No.: US 2007/0026194 A1
(43) Pub. Date: Feb. 1, 2007

(54) SEPARATOR FOR PALLETIZED AND OTHER STACKED MATERIAL

(76) Inventors: Gary D. Werner, Lakewood, CO (US); Charles R. Krupka, Okemos, MI (US)

Correspondence Address: JAMES D. STEVENS;REISING, ETHINGTON, BARNES, KISSELLE, P.C., P.O. BOX 4390, TROY, MI, 48099, US

(21) Appl. No.: 11/460,190

(22) Filed: Jul. 26, 2006

Related U.S. Application Data
(60) Provisional application No. 60/702,536, filed on Jul. 26, 2005.

(51) Int. Cl. G11B 5/64

(52) U.S. Cl. 428/141; 428/304.4

(57) ABSTRACT

A separator sheet for pallets, parts, or other stacked material is formed from a polyolefin such as HDPE using a method that produces a roughened surface on the sheet that helps prevent shifting of the stacked material. The sheets can be made by extruding melted polyolefin through a die, and the roughened surface can be provided by stretching the extruded material through the nip of a pair of rollers run at different temperatures and at a speed that is greater than the extrusion speed of the polyolefin. Alternatively, the heated polyolefin can be provided with a suitable level of moisture content or a foaming agent to obtain the roughened surface. Injection molding techniques can also be used to form the separator sheets.

### CROSS-REFERENCE TO RELATED APPLICATION

This application claims the priority of U.S. Provisional Application No. 60/702,536 filed Jul. 26, 2005, the entire contents of which are hereby incorporated by reference.

### TECHNICAL FIELD

This invention relates to pallet separators and parts separators.

### BACKGROUND OF THE INVENTION

Plywood is primarily used today as a pallet separator and cardboard is primarily used as a parts separator. Both of these materials have a limited life because they can immediately begin to deteriorate upon first use. The fibers of plywood can break as soon as material is placed upon it, the weight of which creates flexion beyond its limits to remain rigid. Repeated uses, as well as the elements of the environment, including sun, rain, wind and snow, cause the fibers to break and separate. This can result in conveyor equipment jamming, splinters and other injuries, as well as scrap on the plant floor or yard which require cleanup. Cardboard, by its nature, offers little resistance to parts placed upon its surface, thereby even more rapidly than plywood, begins the process of deterioration, also leading to conveyor equipment jamming and scrap on the floor and in the yard which require cleanup.

Plywood and cardboard, when it becomes unusable, must be disposed of thereby necessitating the costs associated with its transportation and disposal.

Apart from these structural problems with plywood and cardboard, contamination of these materials can be problematic for various applications such as when being used within the food processing industry. For example, one soft drink manufacturer encountered contamination problems in the late nineteen-nineties as the result of the use of wooden pallets involved in the transportation of its product, and as a result, they have since required the use of plastic pallets and plastic tier sheets.

The general use of polyolefins such as HDPE and other polymers to produce pallets, slip sheets, and other separators is known. See for example: U.S. Pat. No. 3,776,145 to Anderson et al.; 4,422,549 to Werkheiser; 4,428,306 to Dresen et al.; 5,401,563 to Kurata et al.; and 5,894,804 to Werner.

### SUMMARY OF THE INVENTION

In accordance with one aspect of the invention, there is provided a separator sheet for use with pallets, parts, or other stacked material. The separator sheet comprises a sheet of polyolefin material formed using an additive that produces at least one roughened surface on the sheet during formation of the sheet. The additive can be water to provide the polyolefin with a sufficient moisture content during heating and formation of the sheet. Alternatively, the additive can be a foaming agent or can be a rubber.

In accordance with another aspect of the invention, there is provided a method of forming a separator sheet for use with pallets, parts, or other stacked material. The method includes the steps of:

heating a polyolefin material to at least partially melt the polyolefin material;

providing the polyolefin material with an additive;

forming a sheet of the heated material such that the additive produces a roughened surface on the formed sheet; and

cooling the sheet to a lower temperature.

In accordance with yet another aspect of the invention, there is provided a method of forming a separator sheet for use with pallets, parts, or other stacked material, in which the method includes the steps of:

heating a polyolefin material to at least partially melt the polyolefin material;

extruding the heated material through a die;

drawing the extruded material through at least one set of rollers, including an upper roller and a lower roller;

heating the upper and lower rollers to different temperatures during the drawing step; and

running the rollers at a higher speed than the speed of material exiting through the die to thereby cause pulling and stretching of the material as it passes through the rollers.

### DETAILED DESCRIPTION OF THE PREFERRED EMBODIMENTS

In accordance with one embodiment of the invention, a separator sheet is provided which is formed from new or recyclable polyolefins that can be readily extruded or injection molded. As is known in the art, these separator sheets can be used as pallet separators which enable pallets of payload to be stacked upon one another, and as parts separators which enable parts within a pallet to be stacked upon one another.

The separator sheets can be made using sheet extrusion technology that transforms HDPE under heat of 350° F. and suitable pressure into molten plastic and pumps it through a die into flat plastic sheets from 250 mm up to 400 mm thickness and widths up to 3 meters, or 10 feet. This sheet extrusion process can be used to produce single layer sheets as well as complex co-extruded or multi-layer sheets. Plastic tape or other coloring or indicia may be melted into the sheet for identification purposes.

The heated polyolefin material is extruded through a die onto polished rolls where it is formed into a continuous sheet. To obtain the rough surface, the polished rolls are run at different temperatures, 350° F. on the top roll and 325° F. on the bottom rolls, and run at higher speeds than the flow of molten plastic from the die, thereby causing pulling and stretching as the material reaches the nip. As the material is rolled, it cools and cracks and stipples on the surface are created. Another method to create the rough surface is to leave approximately 3% moisture in the material as it enters the extruder, thereby causing the moisture to explode as a gas, leaving the material uneven as it meets the rollers and is cooled. Another method is to use a foaming agent of carbon chloride, which creates carbon dioxide. This may be introduced into the extruder which causes a predictable explosion with unpredictable and uneven results, also leaving the surface rough and uneven. By the time the softened plastic travels the entire conveyor system (e.g., a 60 foot conveyor), it cools to about 110 degrees and hardens after which it is sheared to the correct size.

The polyolefin material used can be a polyolefinic polymer matrix, including HDPE, and, in some cases, up to 20% rubber, thereby creating differing amounts of friction for different uses.

In lieu of extrusion process, the sheets can be made by injection molding. During injection molding, the polyolefin material may also be processed with 3% moisture to create the rough, uneven surface. Also, a foaming agent may be introduced into the injection process to create the rough or uneven surface, and/or the mold surfaces may be machined with a variety of “roughing patterns” to help prevent payloads or parts from shifting while stationary or while being moved or transported.

The resulting composition is dense, stiff and flexible, but not brittle; the surfaces, top and bottom, are rough but do not cause payload or parts to tear or splinter. Their purpose is to provide surfaces with a high co-efficient of friction which cause no harm to the payload or parts but keep stacked material from sliding, especially when they are moved or transported.

One advantage of the invention is that the sheets can be made using waste HDPE and, when a sheet is no longer useful, it can be reground and reprocessed into new separator sheets. This helps avoid the above-noted problems with plywood and cardboard. Furthermore, the life cycle is materially longer than plywood and cardboard, thereby substantially reducing repurchase and all of the costs associated with maintaining inventory levels, buyer and transportation costs associated with repurchase. The plastic separators can be cleaned completely, do not absorb anything and are much safer than plywood.

It is to be understood that the foregoing description is not a definition of the invention, but a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A separator sheet for use with pallets, parts, or other stacked material, comprising:
a sheet of polyolefin material formed using an additive that produces at least one roughened surface on the sheet during formation of the sheet.

2. A separator sheet as defined in claim 1, wherein the additive comprises water mixed into the material prior to full heating of the material.

3. A separator sheet as defined in claim 1, wherein the additive comprises a foaming agent.

4. A separator sheet as defined in claim 1, wherein the sheet is formed from the polyolefin material and rubber.

5. A method of forming a separator sheet for use with pallets, parts, or other stacked material, comprising the steps of:
heating a polyolefin material to at least partially melt the polyolefin material;
extruding the heated material through a die;
drawing the extruded material through at least one set of rollers, including an upper roller and a lower roller;
heating the upper and lower rollers to different temperatures during the drawing step; and
running the rollers at a higher speed than the speed of material exiting through the die to thereby cause pulling and stretching of the material as it passes through the rollers.

6. The method of claim 5, wherein the step of heating the upper and lower rollers further comprises heating at least one upper roller to first temperature and heating one or more lower rollers to a second temperature that is less than the first temperature.

7. The method of claim 5, wherein the step of heating the upper and lower rollers further comprises heating the upper roller(s) to a temperature of about 350° F. and heating the lower roller(s) to a temperature of about 325° F.

8. A method of forming a separator sheet for use with pallets, parts, or other stacked material, comprising the steps of:
heating a polyolefin material to at least partially melt the polyolefin material;
providing the polyolefin material with an additive;
forming a sheet of the heated material such that the additive produces a roughened surface on the formed sheet; and
cooling the sheet to a lower temperature.

9. The method of claim 8, wherein the forming step further comprises injection molding the heated material.

10. The method of claim 8, wherein the forming step further comprises extruding the heated material through a die.

11. The method of claim 10, wherein the forming step further comprises stretching the heated material after being extruded from a die.

12. The method of claim 11, wherein the stretching step further comprises passing the extruded material through the nip of an upper and lower rollers running at a higher speed than the speed at which the heated material is extruded.

13. The method of claim 8, wherein the step of providing the polyolefin material with an additive further comprises processing the polyolefin material such that it includes a desired moisture content, and then carrying out the heating and forming steps using the moisture bearing polyolefin material.

14. The method of claim 13, wherein the forming step further comprises injection molding the moisture bearing polyolefin material.

15. The method of claim 8, wherein the additive comprises water.

16. The method of claim 8, wherein the additive comprises a foaming agent.

17. The method of claim 16, wherein the foaming agent is carbon chloride.

18. The method of claim 8, wherein the additive comprises rubber.

19. The method of claim 8, wherein the polyolefin material comprises a polyolefinic polymer matrix.

20. The method of claim 8, wherein the forming step further comprises extruding the heated material and shaping the extruded material into a continuous sheet having a roughened surface, and wherein the method further comprises cutting the continuous sheet to a desired size after the cooling step.
